(19) United States
(12) Patent Application Publication
(10) Pub. No.: US 2008/0177559 A1
(43) Pub. Date: Jul. 24, 2008

(54) Systems and methods for determining a benchmark price

(75) Inventors: Michael J. Athey, Washington, IL (US); Wende D. Reeser, Washington, IL (US); Lonny J. Finn, Mapleton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/005,307

(22) Filed: Dec. 27, 2007

Related U.S. Application Data
(60) Provisional application No. 60/877,166, filed on Dec. 27, 2006.

(51) Int. Cl. G06Q 99/00

(52) U.S. Cl. 705/1

(57) ABSTRACT

A method is provided for generating an equipment benchmark price based on equipment sales records. In one embodiment, the method includes receiving a request for the equipment benchmark price for a piece of equipment of a first equipment age wherein the equipment benchmark price is associated with a first time period, and receiving a reference price point reflecting and associated with a second equipment age and a second time period. The method further includes determining a value retention schedule including a first value retention rate for the first equipment age and a second value retention rate for the second equipment age, and determining an equipment price index including a first price index data point for the first time period and a second price index data point for the second time period. Finally, the equipment benchmark price is determined based on the reference price point, the first and the second value retention rates, and the first and the second price index data points. The equipment benchmark price may be provided for an assessment of equipment price performance.

### CROSS REFERENCE TO RELATED APPLICATIONS

This application claims the benefit of priority of U.S. Provisional Patent Application No. 60/877,166, filed Dec. 27, 2006.

This application is related to U.S. patent application Ser. No. 11/806,430, filed May 31, 2007, entitled “System and Method for Generating a Chain-weighted Equipment Price Index,” which is incorporated herein by reference in its entirety.

This application is also related to U.S. patent application Ser. No. 11/806,362, filed May 31, 2007, entitled “System and Method for Generating a Value Retention Schedule,” which is incorporated herein by reference in its entirety.

### TECHNICAL FIELD

The present disclosure relates generally to data processing, and more particularly, to systems and methods for determining an equipment benchmark price based on equipment value retention rates and assessments of market conditions.

### BACKGROUND

A benchmark is a point of reference for a measurement. Benchmark prices are used to provide reference points that indicate the value of certain goods or services in the actual or future state of a given market. Benchmark prices are often used as reference price points for trading goods and services. For example, benchmark prices are often calculated for automobiles of certain capacities or certain models (e.g., Blue Book values by make and model). Both buyers and sellers may use benchmark prices, such as Blue Book values, as reference price points when trading automobiles.

Systems and methods have been developed to calculate benchmark prices. For example, U.S. patent application Ser. No. 10/983,170 filed by Howorka et al. discloses a method for deriving benchmarks for trading instruments. The benchmarks for the price of a financial instrument are calculated by an algorithm based on a previous benchmark and a market price. The market price is derived from a deal price and a quote price. The deal price is based on deals conducted since the last benchmark and the quote price is based on bids and offers entered since the last benchmark. For each of the deal and quote prices, a price, weight and scatter are calculated, which are used to calculate a benchmark price, weight and scatter, and a benchmark error.

While conventional systems, such as that disclosed in U.S. patent application Ser. No. 10/983,170, may provide some mechanism for determining benchmark prices for commodities and financial instruments, they are not useful for determining benchmark prices for equipment, such as certain machines and vehicles. Such benchmark prices are difficult to determine because they are affected by a number of factors. Therefore, there is a need to comprehensively assess market conditions and equipment value retention rates associated with specific equipment make, model, and age. Further, there is a need to determine an equipment benchmark price based on the assessments of market conditions and value retention rates when information regarding the specific equipment does not exist or is incomplete.

### SUMMARY OF THE INVENTION

It is to be understood that both the foregoing general description and the following detailed description are exemplary and explanatory only, and are not restrictive of the claimed embodiments.

A method is provided for generating an equipment benchmark price. In one embodiment, the method includes receiving a request for the equipment benchmark price for a piece of equipment of a first equipment age wherein the equipment benchmark price is associated with a first time period, and receiving a reference price point reflecting and associated with a second equipment age and a second time period. The method further includes determining a value retention schedule including a first value retention rate for the first equipment age and a second value retention rate for the second equipment age, and determining an equipment price index including a first price index data point for the first time period and a second price index data point for the second time period. Finally, the equipment benchmark price is determined based on the reference price point, the first and the second value retention rates, and the first and the second price index data points. The equipment benchmark price may be provided for an assessment of equipment price performance.

### BRIEF DESCRIPTION OF THE DRAWINGS

The accompanying drawings, which are incorporated in and constitute a part of this specification, illustrate exemplary embodiments of the invention, and together with the description, serve to explain the disclosed embodiments. In the drawings:

FIG. 1 is a block diagram of an exemplary equipment price management environment consistent with certain embodiments of the present disclosure;

FIG. 2 is a flow chart of exemplary steps to generate a benchmark price consistent with certain embodiments of the present disclosure;

FIG. 3A is an exemplary data table used in generating a value retention schedule consistent with certain embodiments of the present disclosure;

FIG. 3B is another exemplary data table used in generating a value retention schedule consistent with certain embodiments of the present disclosure;

FIG. 3C is another exemplary data table used in generating a value retention schedule consistent with certain embodiments of the present disclosure;

FIG. 3D is another exemplary data table used in generating a value retention schedule consistent with certain embodiments of the present disclosure;

FIG. 4A is another flow chart of exemplary steps to generate a benchmark price consistent with certain embodiments of the present disclosure;

FIG. 4B is an exemplary data table used in generating an equipment price index consistent with certain embodiments of the present disclosure;

FIG. 4C is another exemplary data table used in generating an equipment price index consistent with certain embodiments of the present disclosure; and

FIG. 4D is another exemplary data table used in generating an equipment price index consistent with certain embodiments of the present disclosure.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

In this disclosure, equipment may generally refer to any type of machine, vehicle, or any other type of asset. For purpose of illustration, the term “equipment benchmark price” may refer to one or more reference prices for a piece of equipment, such as a machine. An equipment benchmark price may be an estimated transaction price of a “representative” piece of equipment having a specific make, model, and manufactured year. A “representative” piece of equipment refers to a piece of equipment having average features and average wear and tear for its make, model, and equipment age.

The term “market value” refers to a transaction price for trading a piece of equipment in the marketplace. The term “value retention rate” refers to the ratio of the market value of a piece of equipment of a given age over the market value of a new piece of equipment. The term “equipment price index” refers to either a singular equipment price index data point in a given time period, or an equipment price index over multiple time periods. A time period may be any defined duration of time, such as a year, a quarter, or a month.

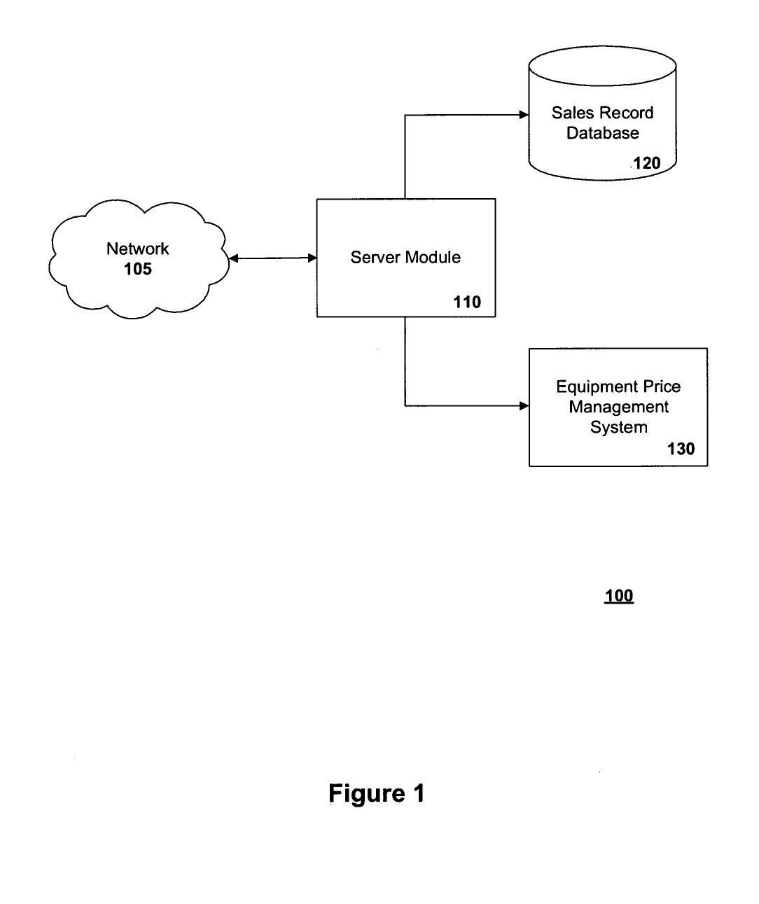

FIG. 1 is a block diagram illustrating an exemplary equipment price management environment 100. Equipment price management environment 100 may include a network 105, a server module 110, a sales record database 120, and an equipment price management system 130. It is contemplated that equipment price management environment 100 may include some, all, or additional components from those illustrated in FIG. 1.

Network 105 may be any type of wireline or wireless communication network for exchanging or delivering information or signals, such as the Internet, a wireless local area network (LAN), or any other network. Thus, network 105 may be any type of communications system. For example, users and systems of equipment price management environment 100 may send or receive data using network 105.

Server module 110 may interface with network 105. Server module 110 may also be directly or indirectly connected to sales record database 120 and equipment price management system 130. Server module 110 may be any type of computer system and may include an interface device (e.g., graphical user interface) that allows a user to access sales record database 120 and/or equipment price management system 130. Further, server module 110 may include additional software/hardware components, such as collaboration tools, that permit users of equipment price management environment 100 to share data and information, and to work together, bulletin boards to permit users to communicate with each other, and/or search engines to provide efficient access to specific entries in sales record database 120 or equipment price management system 130.

One or more memory devices, such as memory devices implemented within server module 110, may also allow users of equipment price management environment 100 to submit records to be added to sales record database 120. As such, server module 110 may include one or more software and/or hardware components that enable a user or software process to manage information contained in equipment price management environment 100. Server module 110 may include any type of Web server and/or application server software, such as Apache HTTP Server from the Apache Software Foundation. Further, server module 110 is not limited to having a server computer and may include any type of computer system.

A user of equipment price management environment 100 may request an equipment benchmark price using server module 110. An equipment benchmark price may include data reflecting the market price of one or more pieces of equipment for one or more time periods. For example, an equipment benchmark price may indicate the representative market price for a one-year-old machine of type A in the first quarter of 2005. The equipment benchmark price may be stored in sales record database 120 or any other memory device accessible by server module 110.

Sales record database 120 may be a system including one or more memory devices and software executed by a processor that is configured to store sales records, charts, entries for changes made to this information, and other information used by users of equipment price management environment 100. A sales record may be any type of new and/or used equipment sales transaction record, such as a retail sales record, an auction sales record, and the like. Equipment price management environment 100 may include one or more sales record databases 120.

In one embodiment, sales record database 120 may include auction sales data records for new and/or used equipment. An auction sales data record may include transactional information for a machine sold at auction, such as the make, model, age, auction price, and ownership data of the machine.

Sales record database 120 may include data used in calculating value retention schedules, such as value retention rates for used equipment, and charts of value retention schedules, etc. A value retention rate refers to the ratio of the market value of a piece of equipment at a certain equipment age (e.g., a two-year-old machine) over the market value of new equipment. A value retention schedule may include one or more value retention rates. A value retention schedule may reflect and measure the value of a piece of equipment over a certain time span, such as from its first use (i.e., zero-year-old) to a certain equipment age. A value retention schedule may be stored and presented in any type of format, such as text, graphics, tables or charts, that are indicative of the market value of a piece of equipment for various equipment ages.

Sales record database 120 may also include data used in calculating an equipment price index, such as the median equipment price of a given time period, and charts of equipment price indices, etc. The equipment price index may include one or more equipment price index data points. For example, a yearly equipment price index for machines of type A may include an equipment price index data point for the year 2000, another equipment price index data point for the year 2001, etc.

Sales record database 120 may further include data used in calculating a benchmark price, such as a reference equipment price in a given time period, and charts of equipment benchmark prices, etc. A reference equipment price refers to a market-determined price (e.g., a transaction price) that is representative of the equipment price in a selected sales channel (e.g., sales through auctions, dealers, etc.) in a specific time period. For example, a reference equipment price may be the median price of all one-year-old machines of type A sold in auctions in the first quarter of 2006. An equipment benchmark price may be determined based on a reference equipment price, the equipment age of the benchmarked equipment, and the market conditions for the equipment.

Equipment price management system 130 may be a computer system or software executed by a processor that is configured to provide access to sales records stored in sales record database 120. Equipment price management system 130 may receive requests from a user of equipment price management environment 100 through server module 110. Equipment price management system 130 may access data records stored in sales record database 120 to perform the calculations to generate equipment benchmark prices as requested by the user. Equipment price management system 130 may also present a requested equipment benchmark price to the user through server module 110.

Equipment price management system 130 may receive transaction data reflecting information associated with equipment sales transactions, such as auction and sales data from used equipment auctions and equipment dealerships. For example, equipment price management system 130 may receive auction sales data for machines of type A. These sales data records may be sent to equipment price management system 130 from, for example, a dealership, an auction organizer, or any other service or individual that may maintain equipment sales data records. The sales data record may include data reflecting equipment age, sales price, date of sale, ownership type, etc. Equipment price management system 130 may receive sales data records of different types of equipment, and from various data sources. Further, equipment price management system 130 may store the sales data records in a database, such as sales record database 120.

In one embodiment, equipment price management system 130 may determine an equipment benchmark price based on auction sales data records stored in sales record database 120. A user may specify the sales channel selected to determine a benchmark price. For example, a user may choose to determine a benchmark retail price for a specific machine make, model, and year. Alternatively, the user may request a benchmark auction price for the same machine type. Depending on the sales channel selected by the user, equipment price management system 130 may apply an estimated sales channel adjustment when calculating benchmark prices.

The user may also specify one or more time periods for the requested equipment benchmark price. For example, the user may request that the equipment benchmark price be determined for one-year-old machines of type A sold in auctions in the first quarter of 2006. In response, equipment price management system 130 may then access and process auction sales data records for the requested equipment stored in sales record database 120 to determine an equipment benchmark price. The equipment benchmark price generated by equipment price management system 130 may reflect the make and model of the requested equipment, the equipment age, and the market conditions for the equipment market for the requested time period. The process for determining the equipment benchmark price is further explained in the following paragraphs.

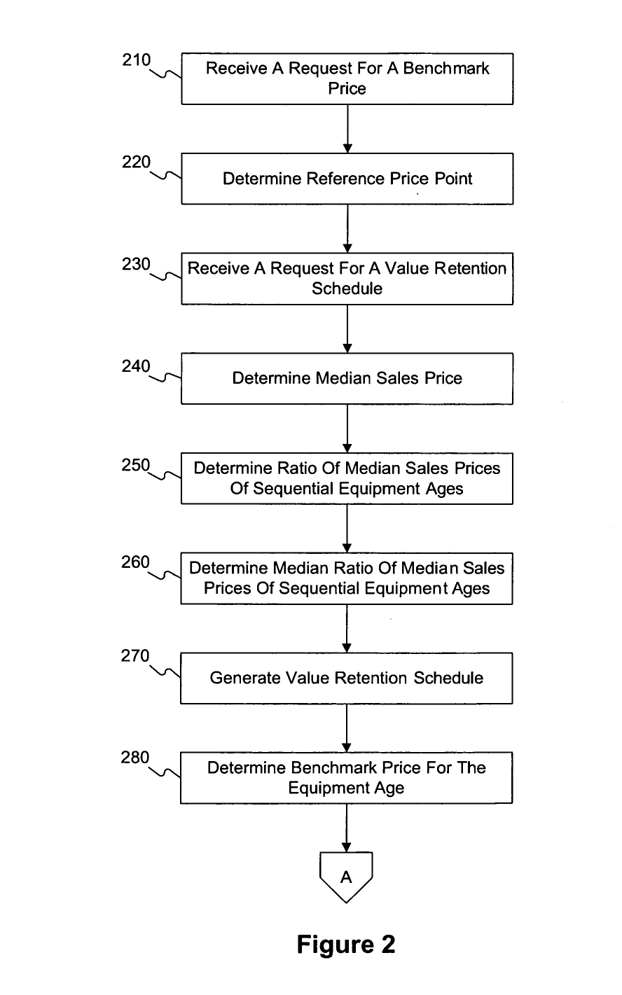

FIG. 2 is a flow chart of exemplary steps for generating an equipment benchmark price consistent with certain embodiments of the present disclosure. First, equipment price management system 130 may receive a user request for an equipment benchmark price (step 210). In one embodiment, a user may request an equipment benchmark price through server module 110. The request may specify the make and model, the equipment age, the sales channel, and the one or more time periods for generating the requested benchmark price. For example, a user may request a benchmark price for a “representative” two-year-old machine of type A. The user may further request that the benchmark price is for machine auctions, and that the benchmark price be reflective of marketing conditions of a particular time period, such as the second quarter of 2006.

Based on the request for the benchmark price, equipment price management system 130 may first receive a reference price point selection (step 220). The user may specify, through server module 110, a reference price point. Alternatively, equipment price management system 130 may determine a reference price point based on other benchmark price calculation rules and user input. The reference price point may be a market determined price, such as the median sales price of a specific type of machine sold at U.S. auctions in a specific time period. The reference price point may be selected based on the data stored in sales record database 120.

In one embodiment, the data stored in sales record database 120 may not include market determined transaction prices for the requested benchmark make and model, equipment age, sales channel, and time periods. As such, the user or a software process may be configured to select a reference price point of an available make and model, equipment age, sales channel, and time periods, and derive the requested benchmark price through extrapolation.

For example, a reference price point may be the median sales price of a three-year-old machine of type A sold at U.S. auctions in the third quarter of 2004. In this example, the reference price point may be $42,000. Equipment price management system 130 may receive the selection of the reference price point from a user. Referring back to the example of machines of type A, the user has requested the benchmark price for a two-year-old machine of type A for the second quarter of 2006. Accordingly, equipment price management system 130 may use the equipment price information from machine auctions to adjust the reference price point ($42,000 for a three-year-old machine of type A in the third quarter of 2004) to determine the requested benchmark price (for a two-year-old machine of type A in the second quarter of 2006).

The benchmark price may be a function of the selected reference price point, equipment ages, and/or the equipment market conditions. In one embodiment, to determine the benchmark price, equipment price management system 130 may first adjust the equipment age of the reference price point (three years old) to the equipment age of the requested benchmark (two years old). Equipment price management system 130 may generate a value retention schedule for the requested equipment make and model. The value retention schedule contains the value retention rates corresponding to the equipment age of the reference price point, and the equipment age of the benchmarked equipment. Equipment price management system 130 may then multiply the reference price point by the value retention rate associated with the benchmarked equipment and divide the product by the value retention rate associated with the reference price point.

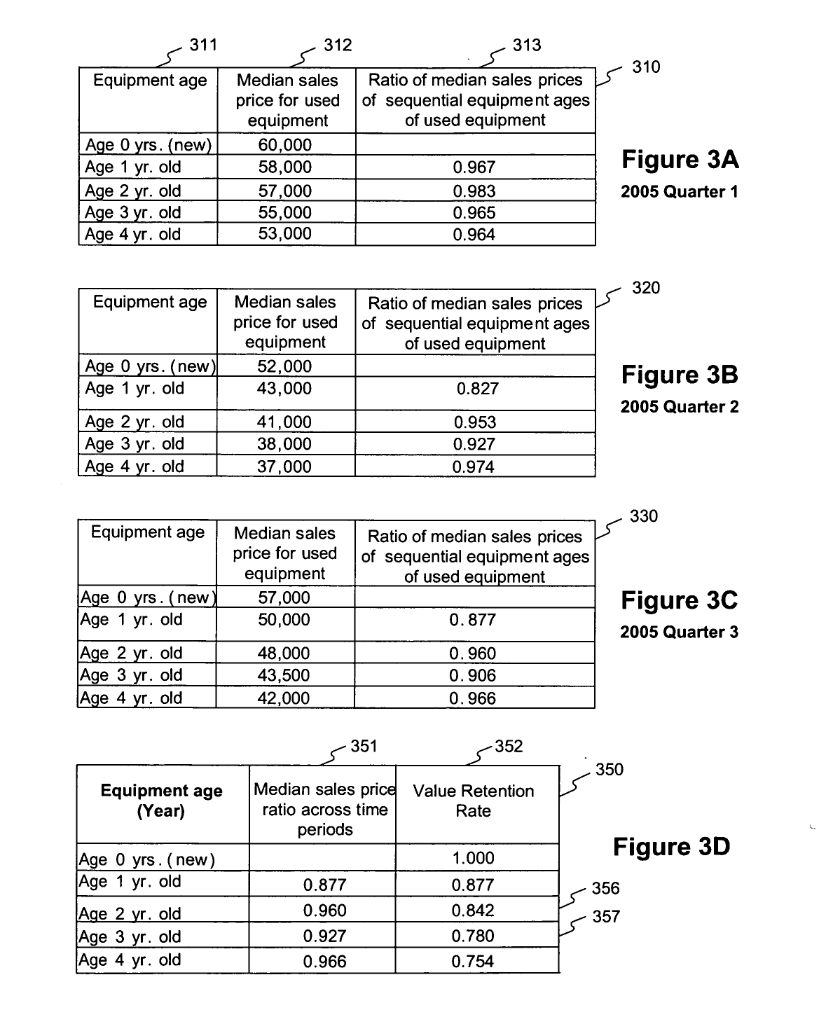

The process for generating a value retention schedule is further described in relation to steps 230-270 in FIG. 2 and the tables in FIGS. 3A-3D. As shown in FIG. 2, equipment price management system 130 may receive a request to generate the value retention schedule (step 230). In one embodiment, a user may request a value retention schedule through server module 110. The request may specify the equipment ages and the one or more time periods for generating the requested value retention schedule. For example, the user may request a value retention schedule for machines of type A for different equipment ages, such as zero, one, two, three, and four years (including the equipment age for reference price point and the equipment age for the benchmark price). The user may further request that the value retention schedule be based on equipment sales completed in auctions in the first three quarters of a particular year, such as 2005.

Based on the request for the value retention schedule, equipment price management system 130 may search sales record database 120 to retrieve sales data records related to the requested equipment. For each requested equipment age, equipment price management system 130 may then determine the median sales price for the requested equipment for each time period (step 240). Referring back to the above example, equipment price management system 130 may retrieve all relevant sales data records for machines of type A from sales records database 120 and then determine the median sales price for machines of type A for each of the three quarters of 2005.

To reduce the effect of outliers in sales prices when determining the value retention schedule, equipment price management system 130 may use the median sales price to generate a requested value retention schedule instead of the mean sales price. FIGS. 3A-3C show tables with sales data associated with machines of type A for the first, second, and third quarter of 2005. Column 311 lists the requested equipment ages of machines of type A. Column 312 lists the median sales price of machines of type A at the requested equipment ages. In this example, column 313 lists data reflecting the ratio of median sales prices of sequential equipment ages. Each row of table 310 includes data related to a specific equipment age of machines of type A. For example, as shown in FIG. 3A, in the first quarter of 2005, the median sales price for a new machine is $60,000; the median sales price for a one-year-old machine is $58,000; the median sales price for a two-year-old machine is $57,000; the median sales price for a three-year-old machine is $55,000; and the median sales price for a four-year-old machine is $53,000. Similarly, equipment price management system 130 may determine the median prices for machines of type A of different equipment ages for the second and third quarters of 2005, as shown in table 320 of FIG. 3B and table 330 of FIG. 3C, respectively.

Referring back to FIG. 2, equipment price management system 130 may then calculate the ratio of median sales prices for each pair of sequential equipment ages (step 250). Equipment price management system 130 may assign the ratio of median sales prices of sequential equipment ages to the older age in the equipment age sequence. As shown in FIGS. 3A-3C, columns 313 of tables 310, 320, and 330 include data reflecting the ratio of median sales prices of sequential equipment ages. For example, equipment price management system 130 may calculate the ratio of the median sales price for the one-year-old machines in the first quarter of 2005 (i.e., one-year-old machines of type A) to the median sales prices for the new machines as:

$58,000/$60,000=0.967 (shown in column 313 of FIG. 3A).

Equipment price management system 130 may then assign this ratio to the older age of the pair of sequential equipment ages (i.e., the older of the zero-year-old and the one-year-old equipment ages), which is the one-year-old equipment age. Similarly, equipment price management system 130 may calculate the ratio of the median sales price for the two-year-old machines to the median sales price for the one-year-old machines as:

$57,000/$58,000=0.983

Equipment price management system 130 may assign the ratio (0.983) to the two-year-old equipment age, which in this example is the older age in the equipment age sequence. The ratios of median sales prices for a machine of type A may be calculated for the three-year-old and the four-year-old machines. Similarly, the ratios of median sales prices of sequential equipment ages may be calculated for the second and third quarters of 2005, as shown in FIGS. 3B and 3C, respectively.

Returning to FIG. 2, for each machine age, equipment price management system 130 may then determine the median sales price ratio of sequential equipment ages across multiple time periods (step 260). FIG. 3D shows an exemplary table 350 with column 351 including data reflecting the median sales price ratio across multiple time periods, and column 352 including data reflecting the value retention rates of a machine of type A at various equipment ages. Referring to FIGS. 3A-3C, the one-year-old machine has an exemplary ratio of median sales prices of 0.967 in the first quarter of 2005, a ratio of 0.827 in the second quarter of 2005, and a ratio of 0.877 in the third quarter of 2005. Therefore, as shown in FIG. 3D, used equipment management system 130 may determine that in this example, the median sales price ratio across the three quarters of 2005 for the one-year-old machine of type A is 0.877.

As shown in FIG. 3D, the median sales price ratio for the two-year-old machines of type A across the three quarters of 2005 is 0.960 (e.g., the median of 0.983, 0.953, and 0.960). The median sales price ratio for the three-year-old machines of type A across the three quarters of 2005 is 0.927 (e.g., the median of 0.965, 0.927, and 0.906). Further, the median sales price ratio for the four-year-old machines of type A across the three quarters of 2005 is 0.966 (e.g., the median of 0.964, 0.974, and 0.966).

The disclosed embodiments take into account that different factors may affect the equipment sales price. For example, the exemplary machine of type A may have different sales prices in different time periods. As shown in FIGS. 3A-3C, the new (i.e., zero-year-old) machine has a median sales price of $52,000 in the second quarter of 2005. However, the new machine may have a median sales price of $57,000 in the third quarter of 2005. Additionally, in the first quarter of 2005, sales prices for used machines of type A of all equipment ages may be different than the second and the third quarters of 2005. These kinds of price fluctuations may be caused by changes in supply and demand of the equipment related to market conditions. Equipment price management system 130 may calculate a value retention schedule using ratios of median sales prices of sequential equipment ages and the median sales price ratio across multiple time periods (e.g., across three quarters of 2005) to reduce the bias of outlier sales prices of equipment.

In another embodiment, equipment price management system 130 may allow a user or software to vary the choice of the time periods (e.g., quarters versus years) to further reduce the impact of outlier transactions on the retention rate calculation. For example, instead of the three quarters used in the example discussed above, used equipment management system 130 may calculate the median sales price ratio (of sequential equipment ages) across multiple years to determine a value retention rate to reduce the impact of other cyclical market conditions across these years.

Returning to FIG. 2, equipment price management system 130 may generate the value retention schedule by calculating the fraction of the market value retained at each equipment age (step 270). The retention rate at each equipment age may be determined by multiplying the median sales price ratio across given time periods for that equipment age by the value retention rate of a previous equipment age (e.g., the equipment age that is one unit of measure newer). In one embodiment, equipment price management system 130 may assume that a new machine maintains 100% of its value and, therefore, may set the value retention rate at 1.0 for the zero-year-old equipment age. For example, in FIG. 3D, equipment price management system 130 may set the value retention rate for the zero-year-old machine at 1.000. Equipment price management system 130 may then calculate the value retention rate of the one-year-old machine by multiplying the value retention rate for the one-year-old machine (i.e., 0.877) by the ratio of the zero-year-old machine (i.e., 1.0), such as:

0.877×1.0=0.877

Therefore, in this example, the one-year-old machine is assigned a value retention rate of 0.877. Similarly, equipment price management system 130 may calculate the retention rate for the two-year-old machine by multiplying the median sales price ratio across time periods for the two-year-old machine (i.e., 0.960) by the value retention rate for the one-year-old machine (i.e., 0.877):

0.960×0.877=0.842

Therefore, the two-year-old machine may be assigned a value retention rate of 0.842. As shown in FIG. 3D, the value retention rate of the three-year-old machine is therefore determined at 0.780 (i.e., 0.927×0.842); and the value retention rate of the four-year-old machine is determined at 0.754 (i.e., 0.966×0.780).

Equipment price management system 130 may also present a value retention schedule to the user. FIG. 3D shows an exemplary value retention schedule 350 that may be presented to a user. As shown in FIG. 3D, value retention schedule 350 may present the value retention rates for various equipment ages across a certain time period. For example, value retention schedule 350 shows an exemplary value retention schedule for the zero, one, two, three, and four-year-old machines of type A, based on the sales data of the first three quarters of 2005.

The value retention schedule 350 may be shown as a graph with the value retention rates. Further, equipment price management system 130 may fit value retention schedule 350 to a curve using various statistical techniques, such as regression. The curve may be the best fit line of value retention schedule 350 showing the value retention rate data by age. The fitted curve of a value retention schedule may be referred to as a value retention curve. Equipment price management system 130 may generate value retention curves by fitting value retention schedule 350 to different types of functions, such as polynomial curves. In another embodiment, equipment price management system 130 may fit another value retention schedule to an exponential curve.

After the value retention schedule 350 for machines of type A is determined, equipment price management system 130 may determine a benchmark price for the requested equipment based on the reference price point and the value retention schedule 350 (step 280). To do so, in one example, equipment price management system 130 may multiply the reference price point (determined in step 220) by the value retention rate associated with the benchmarked equipment and then divide the product by the value retention rate associated with the reference price point.

Referring back to the example of machines of type A, in Step 220, the user selected the median auction price ($42,000) of a three-year-old machine of type A as the reference price point. As shown in FIG. 3D, the value retention rate for a three-year-old machine of type A is 0.780, and the value retention rate for a two-year-old machine of type A is 0.842. As such, equipment price management system 130 may calculate the benchmark price (P_{benchmark}) for a two-year-old machine of type A as follows:

$$\begin{matrix}\begin{matrix}{P}_{benchmark} = {P}_{reference} \times \frac{{V}_{benchmark}}{{V}_{reference}} \\ = \$42 \text{,} 000 \times \frac{0.842}{0.780} \\ = \$45 \text{,} 338.46\end{matrix} & ( 1 )\end{matrix}$$

Where P_{reference} is the reference price point, V_{benchmark} is the value retention rate associated with the equipment age corresponding to the requested benchmark price, and V_{reference} is the value retention rate associated with the equipment age corresponding to the reference price point (e.g., FIG. 3D, 356 and 357). As shown above in equation (1), based on the reference price point and the value retention schedule, equipment price management system 130 may therefore determine that the benchmark price for a two-year-old machine of type A is $45,338.46.

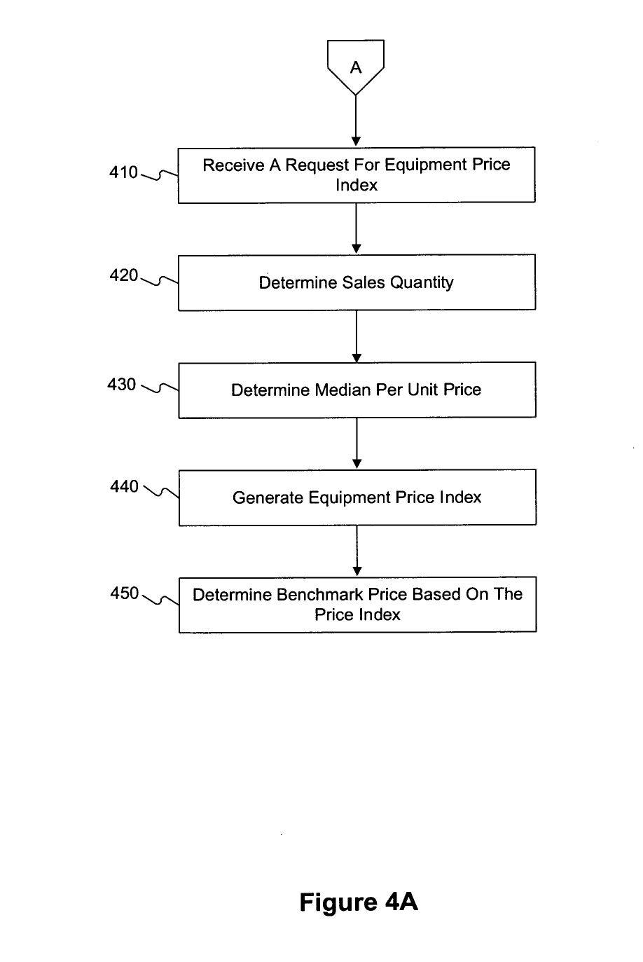

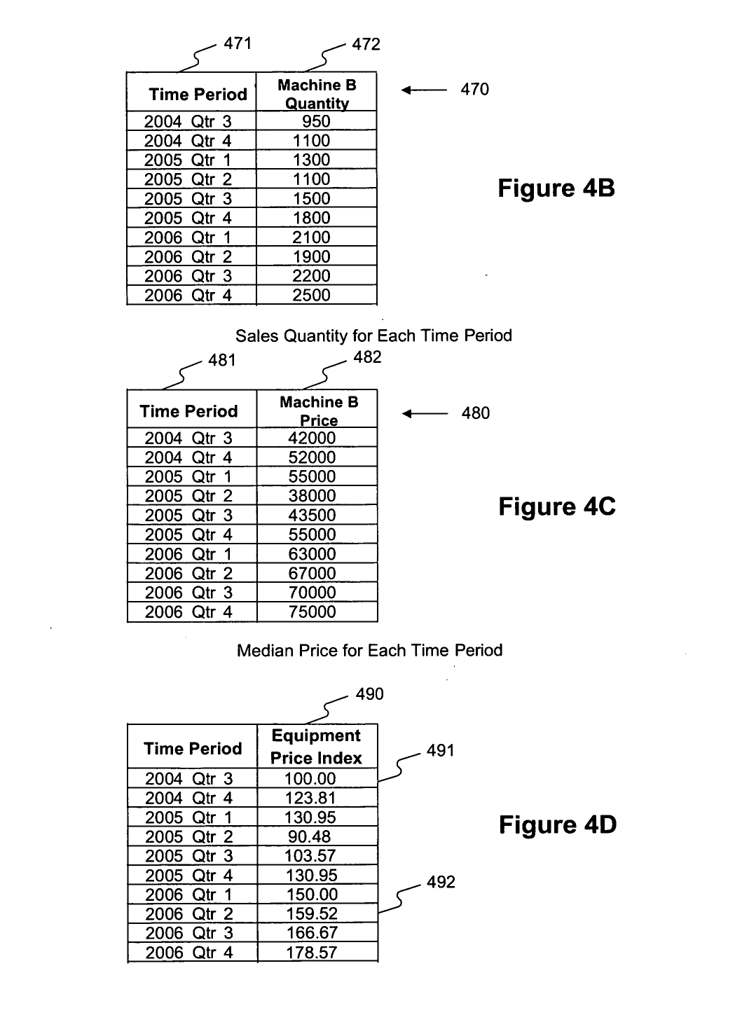

In one embodiment, equipment price management system 130 may decide the equipment benchmark price by considering the equipment age and the value retention rate related to the equipment age, as shown in equation (1). However, to factor market conditions of a specific time period, such as the supply and demand fluctuations for the equipment, into the benchmark price determination, a user may further request that equipment price management system 130 determine a price index for the requested equipment. The process for determining the equipment price index and then further adjusting the benchmark price using the price index is described below in connection with FIGS. 4A-4D.

FIG. 4A is a flow chart of exemplary steps for generating an equipment price index (steps 410-440) and adjusting the benchmark price (step 450) based on the price index, consistent with certain embodiments of the present disclosure. In one embodiment, equipment price management system 130 may receive a request to generate an equipment price index from a user (step 410). In the above example with respect to machines of type A, the user may request an equipment price index to be generated through server module 110. The request may specify an equipment price index for machine type B, for which price movements proxy those of machine type A and which has the necessary data. The request may specify one or more time periods for generating the requested equipment price index. For example, a user may request the equipment price index for three-year-old machines of type B for the ten quarters ranging from the third quarter of 2004 to the fourth quarter of 2006. The user may further request that the equipment price index be based on U.S. auction sales data for three-year-old machines of type B.

Based on the request for the equipment price index, equipment price management system 130 may search sales record database 120 to retrieve auction sales data records related to the requested equipment. Equipment price management system 130 may determine the sales volume for the requested equipment for each time period of the index (step 420). For instance, referring back to the above example, equipment price management system 130 may retrieve all relevant auction sales data records for three-year-old machines of type B from sales record database 120, and then determine the number of three-year-old machines of type B sold in each of the requested ten quarters.

FIGS. 4B-4D show exemplary tables including data reflecting the results of calculating the equipment price index based on the auction sales data for the above example. FIG. 4B shows a table 470 including data reflecting quantities of three-year-old machines of type B sold for each quarter of the year. Column 471 lists the time periods (e.g., the ten quarters) of the requested equipment price index. Column 472 lists the quantity of sales for machines of type B for each of the ten quarters, respectively. For example, as shown in FIG. 4B, 950 machines of type B were sold in the third quarter of 2004.

Returning to FIG. 4A, for each time period of the index, equipment price management system 130 may determine the median per unit sales prices for the requested equipment (step 430). Equipment price management system 130 may determine the median per unit price for each requested equipment type based on the retrieved sales data records. For example, referring back to the above example, FIG. 4C shows an exemplary table 480 including data reflecting the median prices for the requested equipment (e.g., machines of type B) for each time period. Column 481 lists the time periods of the requested equipment price index. Column 482 lists the median auction sales price for a three-year-old machine of type B in each time period, respectively. For example, as shown in FIG. 4C, in the third quarter of 2004, the median sales price for a three-year-old machine of type B was $42,000.

Different factors may affect the equipment sales price. For example, the exemplary machine of type B may have a different sales price for different time periods. As shown in FIG. 4C, a three-year-old machine of type B has a median sales price of $42,000 in the third quarter of 2004. However, a three-year-old machine of type B has a median sales price of $55,000 in the first quarter of 2005. Such price fluctuation may be caused by changes in supply and demand of the equipment related to market conditions. Equipment price management system 130 may use median sales prices in each time period to reduce the bias of outlier sales prices in a given time period.

Based on the determined information, equipment price management system 130 may generate an equipment price index (step 440). Equipment price management system 130 may generate the equipment price index by calculating the equipment price index data point for each time period. In one embodiment, the equipment price index data point for time period t may be determined by the following equation where t=1, 2, . . . and Yₜ=100 when t=1:

$${Y}_{t} = \sqrt{\frac{\sum {P}_{t} {Q}_{t - 1}}{\sum {P}_{t - 1} {Q}_{t - 1}} \times \frac{\sum {P}_{t} {Q}_{t}}{\sum {P}_{t - 1} {Q}_{t}}} \times {Y}_{t - 1} \qquad ( 2 )$$

Yₜ is the equipment price index for time period t. Yₜ₋₁ is the equipment price index for the time period t−1 which directly precedes time period t. For the first time period (i.e., t=1), Yₜ may be set to a specified value, such as 1.0, or 100. Qₜ is the quantity of sales (i.e., volume of sales) for time period t, and Qₜ₋₁ is the quantity of sales for time period t−1. Pₜ is the median sales price for time period t, and P, is the median sales price for time period t−1. ΣPQ is the sum of the product of the median prices and the sales quantities for each type of requested equipment included in the equipment price index. According to the above equation, the equipment price index for a single type and age of equipment for time period t (such as that shown in FIGS. 4B and 4C) may be determined by the following equation:

$${Y}_{t} = \sqrt{\frac{{P}_{t} {Q}_{t - 1}}{{P}_{t - 1} {Q}_{t - 1}} \times \frac{{P}_{t} {Q}_{t}}{{P}_{t - 1} {Q}_{t}}} \times {Y}_{t - 1} .$$

To illustrate this embodiment, the equipment price index for data shown in FIGS. 4B and 4C is demonstrated. In FIGS. 4B and 4C, for the third quarter of 2004 (i.e., t=1), Yₜ (i.e., Y₁) is set to 100. For the fourth quarter of 2004 (i.e., t=2), the equipment price index Y₂ may be calculated as follows:

$$\begin{matrix}{Y}_{2} = \sqrt{\frac{{P}_{2} {Q}_{1}}{{P}_{1} {Q}_{1}} \times \frac{{P}_{2} {Q}_{2}}{{P}_{1} {Q}_{2}}} \times {Y}_{1} \\ = \sqrt{\frac{52000 \cdot 950}{42000 \cdot 950}} \times \sqrt{\frac{52000 \cdot 1100}{42000 \cdot 1100}} \times 100 \\ = 123.81\end{matrix}$$

Therefore, Y₂ for the fourth quarter of 2004 is 123.81. Similarly, Y₃ may be calculated for the first quarter of 2005:

$$\begin{matrix}{Y}_{3} = \sqrt{\frac{{P}_{3} {Q}_{2}}{{P}_{2} {Q}_{2}} \times \frac{{P}_{3} {Q}_{3}}{{P}_{2} {Q}_{3}}} \times {Y}_{2} \\ = 130.95\end{matrix}$$

Equipment price management system 130 may store the determined equipment price indices in a data structure, such as a table, array, etc. For example, FIG. 4D shows table 490 reflecting the equipment price index data points for the rest of the requested quarters in 2005 and 2006.

As the relative price of certain equipment falls, buyers may substitute or update their current inventory with different equipment. If an equipment price index is calculated using a fixed-weight method (e.g., using the base time period index as the weight for all time periods), the drop in price would be underweighted for the time periods beyond the base period. As such, the embodiment disclosed in FIGS. 4B-4D (equation 2) may use a chain-weighted method. As shown in FIGS. 4B-4D (equation 2), for a given quarter, the equipment price index is chain-weighted based on the sales quantities of the current quarter and the previous quarter. The chain-weighted equipment price index lessens the bias caused by buyers shifting their buying patterns in response to equipment price changes.

Equipment price management system 130 may present the equipment price index to the user. For instance, equipment price management system 130 may format the equipment price index data and provide the formatted data to server module 110 for display to the user via a user interface. FIG. 4D shows an exemplary equipment price index representation that may be presented to a user. In FIG. 4D, equipment price index table 490 shows an exemplary equipment price index for three-year-old machines of type B for the ten quarters from 2004 to 2006.

Returning to FIG. 4A, after equipment price management system 130 determines the price index, it may further adjust the benchmark price to reflect the market conditions by applying the price index to the benchmark price (step 450). Based on the reference price point and the value retention schedule, equipment price management system 130 determines the benchmark price for a two-year-old machine of type A to be $45,338.46. Because the user requested the benchmark price for a machine of type A for the second quarter of 2006, equipment price management system 130 may further multiply the benchmark price by the price index associated with the benchmark time period and then divide the product by the price index associated with the reference time period. As such, the benchmark price for a two-year-old machine of type A may be calculated as follows:

$$\begin{matrix}\begin{matrix}{P}_{benchmark} = {P}_{reference} \times \frac{{V}_{benchmark}}{{V}_{reference}} \times \frac{{I}_{benchmark}}{{I}_{reference}} \\ = \$42 \text{,} 000 \times \frac{0.842}{0.780} \times \frac{159.52}{100} \\ = \$72 \text{,} 323.91\end{matrix} & ( 3 )\end{matrix}$$

I_{reference} refers to the equipment price index data point associated with the reference time period, and I_{benchmark} refers to the equipment price index data point associated with the benchmark time period (FIG. 4D, 491 and 492). Based on the reference price point, the value retention schedule, and the price index, equipment price management system 130 may therefore determine the benchmark price for a two-year-old machine of type A for the second quarter of 2006 to be $72,323.91 (equation 3). This equipment benchmark price reflects the value retention rate related to the equipment age associated with the benchmark price (two years old), the value retention rate related to the equipment age of the reference price point (three years old), and the market conditions (price index) for three-year-old machines of type B, for which price movements proxy those of machine type A.

### INDUSTRIAL APPLICABILITY

Methods and systems consistent with the disclosed embodiments allow users and systems to manage used equipment. In one embodiment, a management system may receive and store used equipment sales data. A user may request the management system to generate a value retention schedule. The management system may determine value retention rates and generate one or more value retention schedules for a given type of equipment. The value retention rates and value retention schedules may be used to determine the economic depreciation of the equipment. Such information may be used, for example, to perform tax and other types of financial processes. Additionally, the management system may generate the value retention schedule based on data simulating future equipment sales. Such a forward looking value retention schedule may be used for many types of business planning activities.

Further, methods and systems consistent with the disclosed embodiments enable users to accurately track equipment price performance. For example, in one embodiment, the chain-weighted equipment price index may help a user or software process assess past and current market conditions. Additionally, the chain-weighted equipment price index provides users a more accurate view of the equipment price trends over time.

Methods and systems consistent with the disclosed embodiments enable users to accurately estimate benchmark prices. By incorporating the value retention rates and the price index into the benchmark price calculation, a user may be able to accurately determine the benchmark price of a piece of equipment. The user may be able to choose different time periods and equipment ages when picking a reference price point. Methods consistent with the disclosed embodiments may be used to adjust the reference price point to reflect the appropriate equipment age and market conditions.

Methods and systems consistent with the disclosed embodiments also enable users to switch the equipment ages and/or the time periods of the benchmark prices without the need to select a new reference price point. As shown above, the benchmark price may be calculated for various equipment ages and time periods. Thus, by reapplying the value retention schedule and the equipment price index, a user may adjust the benchmark price to reflect the changed equipment age and/or time period.

Further, methods and systems consistent with the disclosed embodiments enable users to accurately track and compare equipment price performance for different manufacturers, different market segments, and different geographic regions. For example, a dealership may compare the benchmark prices of two competing vehicle models when planning and managing its inventories.

Additionally, methods and systems consistent with the disclosed embodiments enable users to simulate “what if” scenarios when making business decisions. For example, when a business manager is planning for future equipment productions, he or she can load sales record database 120 with simulated sales data and study the benchmark prices to assess future equipment price performance with respect to various business strategies.

Accordingly, the disclosed embodiments provide benchmark prices for managing any type of business assessment related to the equipment identified in a user request and maintained in equipment sales records, etc. Business assessments are not limited to any of the examples disclosed above and may include any type of assessment for purposes of marketing, sales, inventory, management, etc. Further, business assessments may be performed by a user or a software process executed by a processor (e.g., equipment price management system 130), such as an artificial intelligence engine, expert systems, etc.

It will be apparent to those skilled in the art that various modifications and variations can be made in the disclosed embodiments without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims.

What is claimed is:

1. A method for generating an equipment benchmark price, the method including:
receiving a request for the equipment benchmark price for a piece of equipment of a first equipment age wherein the equipment benchmark price is associated with a first time period;
receiving a reference price point reflecting and associated with a second equipment age and a second time period;
determining a value retention schedule including a first value retention rate for the first equipment age and a second value retention rate for the second equipment age;
determining an equipment price index including a first price index data point for the first time period and a second price index data point for the second time period;
determining the equipment benchmark price based on the reference price point, the first and the second value retention rates, and the first and the second price index data points; and
providing the equipment benchmark price for an assessment of equipment price performance.

2. The method of claim 1, further including:
(1) determining a first median sales price of the piece of equipment of the first equipment age for a time period;
(2) determining a second median sales price of the piece of equipment of an equipment age one unit of measure newer than the first equipment age for the time period;
(3) determining a first ratio of the first median sales price to the second median sales price for the time period;
repeating steps (1), (2), and (3) for each time period in a set of time periods;
determining a median ratio based on the determined first ratios across the set of time periods; and
determining the first value retention rate for the first equipment age based on the determined median ratio.

3. The method of claim 2, further including:
assigning the first value retention rate to the first equipment age.

4. The method of claim 3, further including:
generating the value retention schedule based on one or more determined value retention rates corresponding to one or more equipment ages.

5. The method of claim 1, further including:
determining a first equipment quantity for the first time period and a second equipment quantity for a time period directly preceding the first time period;
determining a first median price of the first equipment quantity for the first time period and a second median price of the second equipment quantity for the preceding time period; and
determining the first equipment price index data point based on the first and second equipment quantities and the first and the second median prices.

6. The method of claim 1, wherein the equipment price index is chain-weighted.

7. The method of claim 1, further includes:
determining a first product of the reference price point, the first value retention rate, and the first equipment price index data point; and
determining the equipment benchmark price by dividing the first product by the second value retention rate and further by the second equipment price index data point.

8. A computer system, comprising:
a database containing equipment sales records; and
a processor configured to:
receive a request for the equipment benchmark price for a piece of equipment of a first equipment age wherein the equipment benchmark price is associated with a first time period;
receive a reference price point reflecting and associated with a second equipment age and a second time period;
determine a value retention schedule including a first value retention rate for the first equipment age and a second value retention rate for the second equipment age;
determine an equipment price index including a first price index data point for the first time period and a second price index data point for the second time period;
determine the equipment benchmark price based on the reference price point, the first and the second value retention rates, and the first and the second price index data points; and
provide the equipment benchmark price for an assessment of equipment price performance.

9. The system of claim 8, wherein the processor is further configured to:
(1) determine a first median sales price of the piece of equipment of the first equipment age for a time period;
(2) determine a second median sales price of the piece of equipment of an equipment age one unit of measure newer than the first equipment age for the time period;
(3) determine a first ratio of the first median sales price to the second median sales price for time period;
repeat steps (1), (2), and (3) for each time period in a set of time periods;
determine a median ratio based on the determined first ratios across the set of time periods; and
determine the first value retention rate for the first equipment age based on the determined median ratio.

10. The system of claim 9, wherein the processor is further configured to:
assign the first value retention rate to the first equipment age.

11. The system of claim 10, wherein the processor is further configured to:
generate the value retention schedule based on one or more determined value retention rates corresponding to one or more equipment ages.

12. The system of claim 8, wherein the processor is further configured to:
determine a first equipment quantity for the first time period and a second equipment quantity for a time period directly preceding the first time period;
determine a first median price of the first equipment quantity for the first time period and a second median price of the second equipment quantity for the preceding time period; and
determine the first equipment price index data point based on the first and second equipment quantities and the first and the second median prices.

13. The system of claim 8, wherein the equipment price index is chain-weighted:

14. The system of claim 8, wherein the processor is further configured to:
determine a first product of the reference price point, the first value retention rate, and the first equipment price index data point; and
determine the equipment benchmark price by dividing the first product by the second value retention rate and further by the second equipment price index data point.

15. A computer-readable medium for use on a computer system configured to generate an equipment benchmark price, the computer-readable medium having computer-executable instructions for performing a method when executed by a processor, the method including:
receiving a request for the equipment benchmark price for a piece of equipment of a first equipment age wherein the equipment benchmark price is associated with a first time period;
receiving a reference price point reflecting and associated with a second equipment age and a second time period;
determining a value retention schedule including a first value retention rate for the first equipment age and a second value retention rate for the second equipment age;
determining an equipment price index including a first price index data point for the first time period and a second price index data point for the second time period;
determining the equipment benchmark price based on the reference price point, the first and the second value retention rates, and the first and the second price index data points; and
providing the equipment benchmark price for an assessment of equipment price performance.

16. The computer-readable medium of claim 15, wherein the method further includes:
(1) determining a first median sales price of the piece of equipment of the first equipment age for a time period;
(2) determining a second median sales price of the piece of equipment of an equipment age one unit of measure newer than the first equipment age for the time period;
(3) determining a first ratio of the first median sales price to the second median sales price for the time period;
repeating steps (1), (2), and (3) for each time period in a set of time periods;
determining a median ratio based on the determined first ratios across the set of time periods; and
determining the first value retention rate for the first equipment age based on the determined median ratio.

17. The computer-readable medium of claim 16, wherein the method further includes:
assigning the first value retention rate to the first equipment age.

18. The computer-readable medium claim 17, wherein the method further includes:
generating the value retention schedule based on one or more determined value retention rates corresponding to one or more equipment ages.

19. The computer-readable medium of claim 15, wherein the method further includes:
determining a first equipment quantity for the first time period and a second equipment quantity for a time period directly preceding the first time period;
determining a first median price of the first equipment quantity for the first time period and a second median price of the second equipment quantity for the preceding time period; and
determining the first equipment price index data point based on the first and second equipment quantities and the first and the second median prices.

20. The computer-readable medium of claim 15, wherein determining the equipment benchmark price further includes:
determining a first product of the reference price point, the first value retention rate, and the first equipment price index data point; and
determining the equipment benchmark price by dividing the first product by the second value retention rate and further by the second equipment price index data point.
